(19) United States
(12) Patent Application Publication
(10) Pub. No.: US 2007/0006095 A1
(43) Pub. Date: Jan. 4, 2007

(54) Auto layout of user interface elements in a window

(76) Inventor: Liangkui Feng, San Ramon, CA (US)

Correspondence Address: PATENT LAW GROUP LLP, 2635 NORTH FIRST STREET, SUITE 223, SAN JOSE, CA, 95134, US

(21) Appl. No.: 11/173,399

(22) Filed: Jul. 1, 2005

(51) Int. Cl. G06F 17/00

(52) U.S. Cl. 715/800; 715/765; 715/517

(57) ABSTRACT

A method is provided for laying out a child element in a parent element in a window. If a dimension of the child element is fixed, the method includes (1) allocating a fixed dimension to the child element from a remaining dimension of the parent element that has not been allocated. If the dimension of the child element is variable based on a content of the child element, the method includes (2) determining a required dimension based on the content of the child element and (3) allocating the required dimension to the child element from the remaining dimension of the parent element. If the dimension of the child element is proportional based on a weight of the child element and the remaining dimension of the parent element, the method includes (4) determining a proportional dimension of the child element and (5) allocating the proportional dimension to the child element.

### FIELD OF INVENTION

This invention relates to the automatic layout of a window for a software application when the user resizes the window and when the software application is adapted for different languages.

### DESCRIPTION OF RELATED ART

When a user starts a software application in a window environment on a computer, the software application appears as a window of a predetermined size. The window often contains panels, texts, buttons, and spacing. The user may wish to resize the window for better viewing. Thus, what is needed is a method for the software application to resize its window.

Often the design of a software application is a collaboration between the computer programmers that write the underlying codes of the software application and the graphic artists that create the user interface (e.g., the window) that the user sees. The graphic artists often create the user interface for a specific language. When the software application is sold in a new market, the graphic artists have to resize the various elements in the user interface to accommodate the language of the new market. The software may also have run time dynamic changes stemming from the application logic changing the layout of the elements in a window. Thus, what is needed is a method for the user interface of the software application to easily adapt to different languages.

### BRIEF DESCRIPTION OF THE DRAWINGS

FIGS. 1A, 1B, and 1C illustrate a window for a software application in one embodiment of the invention.

FIGS. 2, 3, 4, and 5 illustrate a method to automatically layout a user interface element with horizontally arranged child elements in one embodiment of the invention.

FIGS. 6, 7, and 8 illustrate a method to automatically layout a user interface element with vertically arranged child elements in one embodiment of the invention.

Use of the same reference numbers in different figures indicates similar or identical elements.

### SUMMARY

A method is provided for laying out a child element in a parent element in a window. If a dimension of the child element is fixed, the method includes (1) allocating a fixed dimension to the child element from a remaining dimension of the parent element that has not been allocated. If the dimension of the child element is variable based on a content of the child element, the method includes (2) determining a required dimension based on the content of the child element and (3) allocating the required dimension to the child element from the remaining dimension of the parent element. If the dimension of the child element is proportional based on a weight of the child element and the remaining dimension of the parent element, the method includes (4) determining a proportional dimension of the child element and (5) allocating the proportional dimension to the child element.

### DETAILED DESCRIPTION

In one embodiment of the invention, the following definitions and rules are set for an automatic layout method. A user interface (UI) element can be a panel element or a leaf element. A panel element usually contains other panel elements, leaf elements, or a combination thereof. A leaf element has width and height that can be determined and in turn set the width and height of the panel element that contains the leaf element. Examples of a leaf element include a text, a space, a button, or a user defined element (e.g., a pane in an application window that contains content).

A panel element has two types of layout. A panel element has a horizontal layout when the child elements within it are arranged horizontally (one beside another). The horizontal layout is in either a single line mode or a multiple lines mode. In the single line mode, the child element is laid out in a single line where any portion of the element that exceeds the maximum line width is not displayed In multiple lines mode, the child element can continue in additional lines when it alone or in combination with the preceding child elements exceeds the maximum line width. A panel element has a vertical layout when the child elements within it are arranged vertically (one on top another). The vertical layout can only be single line mode.

The height of a panel or leaf element can be fixed (SFS), proportional to available height (SPR) (proportional), or dependent on the size of its content (SBC). The width of a panel element can be fixed (SFS) or proportional to the available width (SPR) but not dependent on the size of its content. Unlike a panel element, the width of a leaf element can be fixed (SFS), proportional to the available width (SPR), or dependent on the size of its content (SBC).

Each SPR element is assigned a weight and optionally a minimum dimension The dimension of the SPR element is equal to the greater of the minimum dimension and the proportional dimension. The proportional dimension is determines as follows:

$$Dimension = \frac{Weight}{TotalWeight} RemainingWidth \qquad ( 1 )$$

Each SBC element has a height that depends on its content and its width. For example, for a text box that contains a paragraph of tax, the height of the text box depends on its width and how many lines the text take up due to the width of the text box.

In one embodiment, each UI element is described by XML language. To avoid writing XML codes, a graphic artist can use a design tool (i.e., another software application) to compose the UI elements for a software application. The very same design tool can output a list of UI elements for the programmer to use in their design of the underlying logic of the software application.

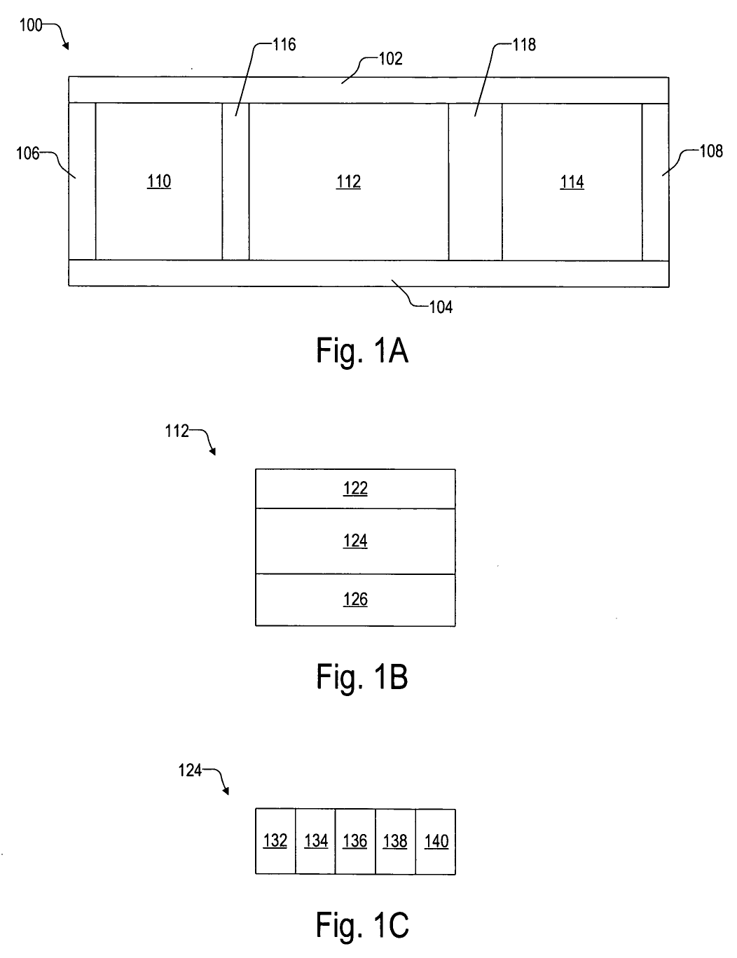

FIGS. 1A, 1B, and 1C are the graphical representation of the XML description of the user interface for a software application.

FIG. 1A illustrates a user interface (UI) element 100 in one embodiment of the invention. UI element 100 may be the main window of a software application. For example, UI element 100 is a panel with a horizontal layout. Panel 100 includes a top margin 102, a bottom margin 104, a left margin 106, a right margin 108, and child elements 110, 112, 114, 116, and 118. For example, child element 110 is a panel with a vertical layout, child element 116 is a spacing element, child element 112 is a horizontal panel, child element 118 is a spacing element, and child element 114 is a text box element.

FIG. 1B illustrates panel 110 in one embodiment of the invention. Panel 110 includes UI elements 122, 124, and 126. For example, UI element 122 is a text element, UI element 124 is a panel with a horizontal layout, and UI element 126 is text element.

FIG. 1C illustrates panel 124 in one embodiment of the invention. For example, panel 124 includes UI elements 132, 134, 136, 138, and 140. UI elements 132, 134, 138, and 140 are button elements.

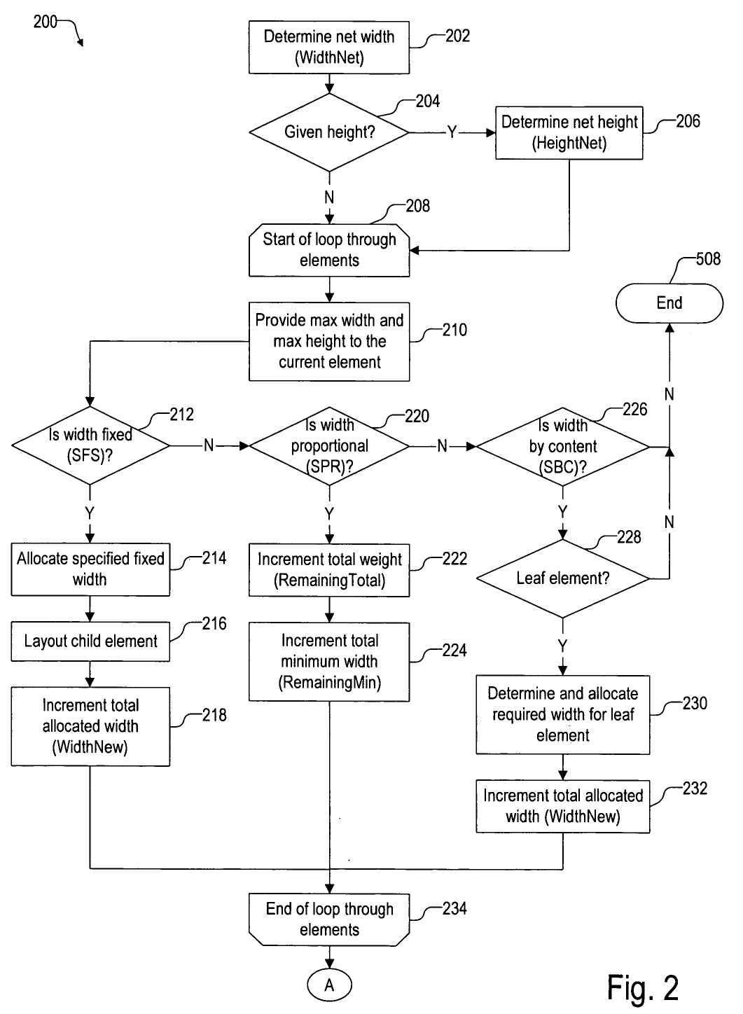

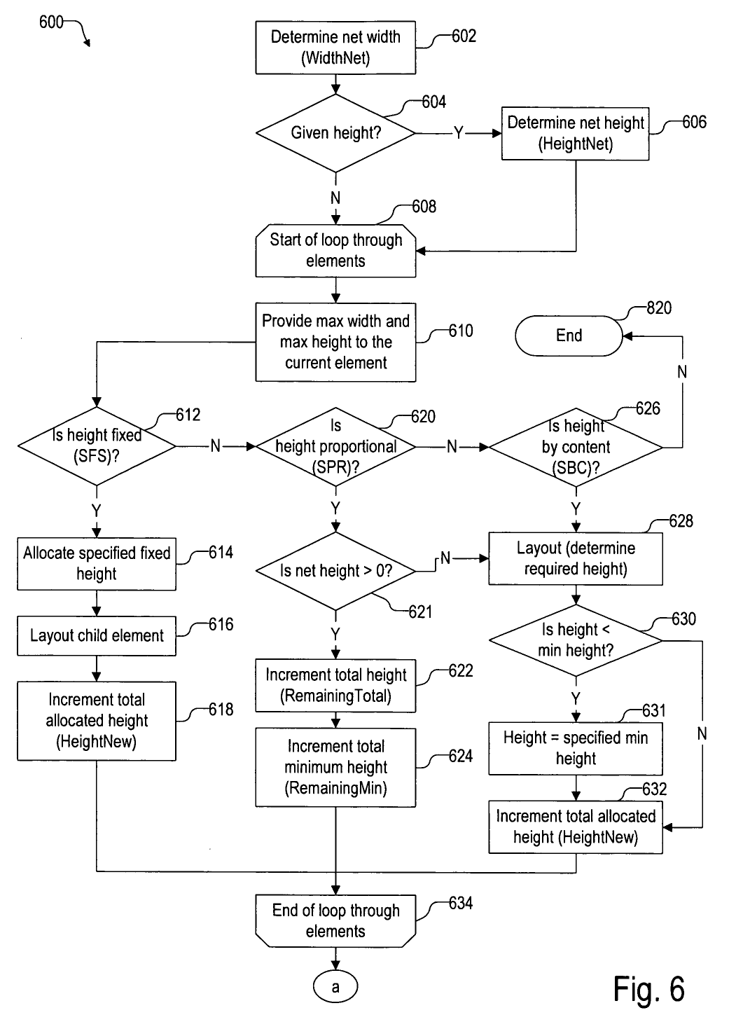

FIGS. 2 to 5 are a flowchart for a method 200 to layout a parent element with horizontally arranged child elements in one embodiment of the invention. FIGS. 6 to 8 are a flowchart for a method 600 to layout a parent element with vertically arranged child elements in one embodiment of the invention. Methods 200 and 600 may be used when a user resizes the main window of a software application. The goal of the automatic layout method is to determine the height, the width, and the starting point of each UI element.

Referring to FIG. 2, in step 202, the processor determines the net width of the parent element (WidthNet). The net width is equal to the set width of the parent element minus any left margin and right margin. If the parent element is the root element, then the set width of the parent element can be a default width when the software application initially starts or a width set by the user when he or she resizes the root element (i.e., when the user resizes the main window for the software application). Otherwise the set width of the parent element is allocated to it by the processing of its parent element. If the net width is less than 0, the parent element is skipped because there is no way to layout the parent element. Step 202 is followed by step 204.

In step 204, the processor determines if the parent element has a set height. If the parent element has a set height, then step 204 is followed by step 206 where a net height is determined. The parent element has a set height when it is the root element. The set height of the root element can be a default height when the software application initially starts or a height set by the user when he or she resizes the root element (i.e., when the user resizes the main window for the software application). If the parent element does not have a set height, then step 204 is followed by step 208 where a loop is initialed through the child elements of the parent element. This is because the height of the parent element now depends on the height of its child elements. If the parent element does not have any child elements (thus it is a leaf element), then its height depends on its content (e.g., the actual text in a text element or the actual button in a button element).

In step 206, the processor determines the net height of the parent element (HeightNet). The net height is equal to the set height of the parent element minus any top margin and bottom margin.

In step 208, the processor starts to loop through child elements within the parent element. Step 208 is followed by step 210.

In step 210, the processor sets the maximum width available for the current child element equal to the net width. If the current child element has a fixed height, then the processor sets the maximum height available for the current child element as the fixed height. The fixed height is specified in the XML code for the child element. If the current child element does not have a fixed height, the processor sets the maximum height available for the current child element equal to the net height. Note that in the first pass through step 210, the net height is set to a value without any limit. Step 210 is followed by step 212.

In step 212, the processor determines if the current child element has a fixed width. In other words, the processor determines if the current child element is a SFS element. If so, step 212 is followed by step 214. Otherwise step 212 is followed by step 220.

In step 214, the processor allocates the fixed width to the child element. The fixed width is specified in the XML code for the child element. If there is insufficient width to allocate to all the child elements with fixed widths, then later child elements in the horizontal arrangement are cropped. Step 214 is followed by step 216.

In step 216, the processor determines the layout of the current child element using method 200 or 600 depending on the arrangement of its child elements (grandchild elements of the parent element). Thus, the overall process is recursive. If any element has a child element, then the processor first determines the layout of the child element. At the end of step 216, the processor has determined the width, the height, and the starting point of the current child element (e.g., the upper left corner of the current child element). Step 216 is followed by step 218.

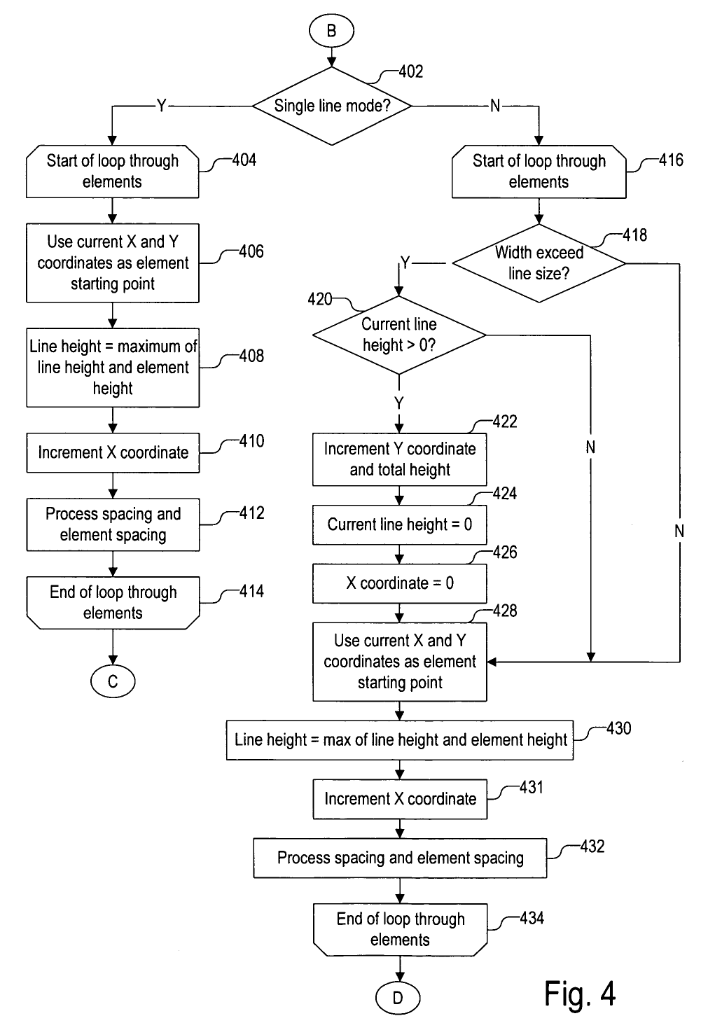

In step 218, the processor increments the total allocated width to all child elements (WidthNew) by the allocated width to the current child element (Width). Furthermore, the processor increments the total allocated width to all child elements (WidthNew) by the width of a default space element if neither the current child element nor the next child element is a space element. This is because a default space element will be inserted between the current child element and the next child element in step 432 (FIG. 4) if neither of them is a space element. Step 218 is followed by step 234.

In step 220, the processor determines if the current child element has a width that is to be proportional to the available width. In other words, the processor determines if the current child element is a SPR element. If so, step 220 is followed by step 222. Otherwise step 220 is followed by step 226.

In step 222, the processor increments the total weight of all SPR elements (RemainingTotal) by the weight of the current child element (WidthSpecified). The weight is specified in the XML code for the current child element. Step 222 is followed by step 224.

In step 224, the processor increments the total minimum width of all SPR elements (RemainingMin) by the minimum width of the current child element (WidthMinFixed), if any. The minimum width is specified in the XML code for the current child element. Step 224 is followed by step 234.

In step 226, the processor determines if the child element has a width that is determined by the size of its content. In other words, the processor determines if the current child element is a SBC element. If so, then step 226 is followed by step 228. Otherwise step 226 is followed by step 508, which ends method 200. In actuality, step 226 is always followed by step 228 because the child element must be a SBC element if it is not a SFS element or a SPR element.

In step 228, the processor determines if the child element is a leaf element. If so, then step 228 is followed by step 230. Otherwise step 228 is followed by step 508, which ends method 200. In actuality, step 228 is always followed by step 230 because only a leaf element can have width dependent on its content.

In step 230, the processor determines the required width for the child leaf element and allocates the required width to the child leaf element. The required width of the child leaf element depends on its content. For example, the width of a text element depends on the length of the text itself. If the required width is greater than the minimum width for the child leaf element, then the required width is set equal to the minimum width of the child leaf element. The minimum width is specified in the XML code for the child leaf element. At the end of step 230, the processor would have determined the width, the height, and the upper left comer of the current child leaf element. Step 230 is followed by step 232.

In step 232, the processor increments the total allocated width to all child elements (WidthNew) by the allocated width to the current child leaf element (Width). Furthermore, the processor increments the total allocated width to all child elements (WidthNew) by the width of a default space element if neither the current child element nor the next child element is a space element. Step 232 is followed by step 234.

In step 234, the processor loops to step 208 if there is a child element that has not been processed. Otherwise step 234 is followed by step 302.

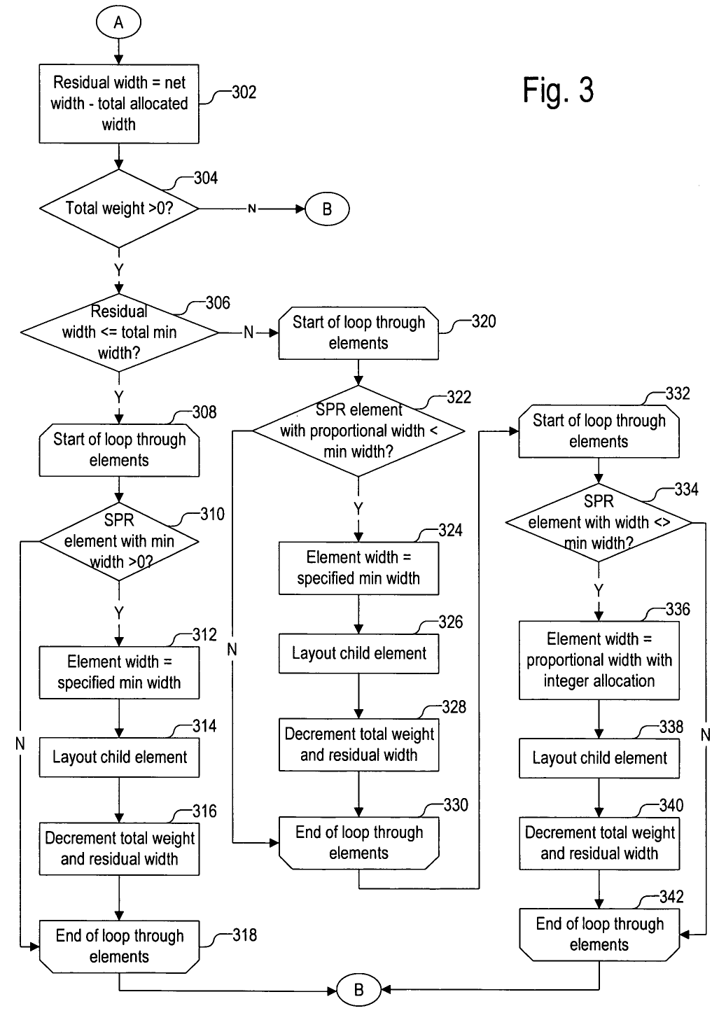

Referring to FIG. 3, in step 302, the processor determines the remaining width that has not been allocated to the child elements (WidthRemaining). The remaining width (WidthRemaining) is equal to the net width (WidthNet) minus the total allocated width to all child elements (WidthNew). Step 302 is followed by step 304.

In step 304, the processor determines if the total weight of all SPR elements (RemainingTotal) is greater than zero. In other words, the processor determines if at least one of the child elements is a SPR element. If so, then step 304 is followed by step 306. Otherwise step 304 is followed by step 402.

In step 306, the processor determines if the remaining width (WidthRemaining) is less than or equal to the total minimum width of all SPR elements (WidthMinimum). If so, then it is not possible to proportionally allocate the remaining width to all the SPR elements and meet their specified minimum widths. If the remaining width (WidthRemaining) is less than or equal to the total minimum width of all SPR elements (WidthMinimum) then step 306 is followed by step 308. Otherwise step 306 is followed by step 320.

In step 308, the processor starts to loop through the child elements. Step 308 is followed by step 310.

In step 310, the processor determines if the current child element is a SPR element and has a minimum width (WidthMinFixed) greater than zero. In other words, the processor determines if the current child element is a SPR element and has a specified minimum width If so, step 310 is followed by step 312. Otherwise step 310 is followed by step 318. The result of this step is that if there is insufficient width to allocate to all SPR elements, then any SPR element without a minimum width would not be displayed.

In step 312, the processor allocates to the current child element its minimum width. The minimum width is specified in the XML code for the current child element. Step 312 is followed by step 314.

In step 314, the processor determines the layout of the child element. At the end of step 314, the processor has determined the width, the height, and the starting point of the current child element (e.g., the upper left comer of the current child element). Step 314 is followed by step 316.

In step 316, the processor decrements the total weight of all SPR elements (RemainingTotal) by the weight of the current child element. The weight is specified in the XML code for the current child element. The processor also decrements the remaining width that has not been allocated to the child elements (WidthRemaining) by the allocated width to the current child element (Width). Step 316 is followed by step 318.

In step 318, the processor loops to step 308 if there is a child element that has not been processed. Otherwise step 318 is followed by step 402.

In step 320, the processor starts to loop through the child elements. Step 320 is followed by step 322.

In step 322, the processor determines if the current child element is a SPR element and has a proportional width that is less than its minimum width. The processor determines the proportional width of the current child element using Equation 1 described above. If so, then step 322 is followed by step 324. Otherwise step 322 is followed by step 330.

In step 324, the processor allocates the minimum width to the current child element. The minimum width is specified in the XML code for the current child element. Step 324 is followed by step 326.

In step 326, the processor determines the layout of the child element. At the end of step 326, the processor has determined the width, the height, and the starting point of the current child element (e.g., the upper left comer of the current child element). Step 326 is followed by step 328.

In step 328, the processor decrements the total weight of all SPR elements (RemainingTotal) by the specified weight of the current child element. The weight is specified in the XML code for the current child element. The processor also decrements the remaining width that has not been allocated to the child elements (WidthRemaining) by the allocated width to the current child element (Width). Step 328 is followed by step 330.

In step 330, the processor loops to step 320 if there is a child element that has not been processed. Otherwise step 330 is followed by step 332.

In step 332, the processor starts to loop through the child elements. Step 332 is followed by step 334.

In step 334, the processor determines if the current child element is a SPR element and has a width greater than or less than its specified minimum width. In other words, the processor determines if the current child element is a SPR element that has been allocated its minimum width in the loop through steps 320 to 330. If so, then step 334 is followed by step 336. Otherwise step 334 is followed by step 342.

In step 336, the processor allocates a width to the current child element according to equation 1. In one embodiment, an integer allocation algorithm is implemented to use all remaining width when the remaining width is not equally divisible among the child element Step 336 is followed by step 338.

In step 338, the processor determines the layout of the current child element. At the end of step 338, the processor has determined the width, the height, and the starting point of the current child element (e.g., the upper left comer of the current child element). Step 338 is followed by step 340.

In step 340, the processor decrements the total weight of all SPR elements (RemainingTotal) by the weight of the current child element. The weight is specified in the XML code for the current child element. The processor also decrements the remaining width that has not been allocated to the child elements (WidthRemaining) by the allocated width to the current child element (Width). Step 340 is followed by step 342.

In step 342, the processor loops to step 332 if there is a child element that has not been processed. Otherwise step 342 is followed by step 402.

Referring to FIG. 4, in step 402, the processor determines if the parent element is in the single line mode. If so, step 402 is followed by step 404. Otherwise step 402 is followed by step 416. Also in step 402, the current X coordinate (Left) and the current Y coordinate (Top) are initialized as zero. The processor uses these two variables are used to track the current location in a horizontal line that it is handling. The current location is used as the starting point of the current child element.

In step 404, the processor starts to loop through the child elements. Step 404 is followed by step 406.

In step 406, the processor uses the current X coordinate (Left) and the current Y coordinate (Top) as the starting point for the current child element and places the child element at the current X and Y coordinates. Note that the current Y coordinate remains at zero in the single line mode of the horizontal layout mode. Step 406 is followed by step 408.

In step 408, the processor sets the line height (HeightNew) for the current line as the greater of the current line height (HeightNew) and the height of the current child element (Height). In other words, the processor sets the line height for the current line as the greatest of the heights of all the child elements located on the current line. Step 408 is followed by step 410.

In step 410, the processor increments the X coordinate (Left) by the allocated width of the current child element (Width) to advance to the next child element. Step 410 is followed by step 412.

In step 412, the processor handles the spacing and element spacing by inserting a default space element after the current child element if neither the current child element nor the next child element is a space element. Step 412 is followed by step 414.

In step 414, the processor loops to step 404 if there is a child element that has not been processed. Otherwise step 414 is followed by step 502.

In step 416, the processor starts to loop through the child elements. Step 416 is followed by step 418.

In step 418, the processor determines if the current child element fits in the current line when inserted behind any preceding child elements. The processor does this by determining if the sum of the allocated widths of the preceding child elements and the current child element is greater than the line width of the (WidthNet) of the parent element. If so, then step 418 is followed by step 420. Otherwise step 418 is followed by step 428.

In step 420, the processor determines if there is at least one child element in the new line that is not a space element so it does not form a new line that is blank. The processor does this by determining if the line height of the current child element (HeightLine) is greater than zero. This guarantees that. If so, then step 420 is followed by step 422. Otherwise step 420 is followed by step 428.

In step 422, the processor increments both the Y coordinate (Top) and the total line height (HeightNew) by the line height of the current line (HeightLine). The total line height is the sum of the heights of all the lines and the line spacing provided between them. Step 422 is followed by step 424.

In step 424, the processor resets the line height of the current line (HeightLine) to zero. This is done in preparation to track the height of a new line to be created. Step 424 is followed by step 426.

In step 426, the processor resets the X coordinate to zero to start a new line. Step 426 is followed by step 428.

In step 428, the processor uses the current X coordinate (Left) and the current Y coordinate (Top) as the starting point for the current child element and places the child element at the current X and Y coordinates. Step 428 is followed by step 430.

In step 430, the processor sets the line height (HeightLine) for the current line as the greater of the current line height (HeightLine) and the height of the current child element (Height). In other words, the processor sets the line height for the current line as the greatest of the heights of all the child elements located on the current line. Step 430 is followed by step 431.

In step 431, the processor increments the X coordinate (Left) by the allocated width of the current child element (Width) to advance to the next child element. Step 431 is followed by step 432.

In step 432, the processor processes the spacing and element spacing. Normally a default space element is inserted between adjacent child elements. However, the default space element is not inserted when one of the adjacent child elements is already a space element. Step 432 is followed by step 434.

In step 434, the processor loops to step 416 if there is a child element that has not been processed. Otherwise step 434 is followed by step 502.

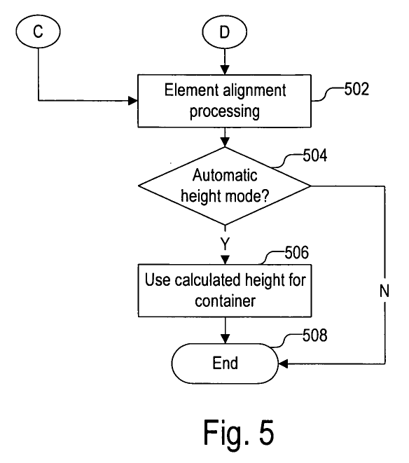

In FIG. 5, in step 502, the processor performs element alignment processing. Each child element can be set to one of three alignment groups: left aligned, centered, and right aligned. The alignment group for each child element is specified in the XML code for the child element. If the alignment group is not specified, the child element by default belongs to the left aligned group. In the multiple line mode, all child elements must belong in the same alignment group. Step 502 is followed by step 504.

In step 504, the processor determines if the parent element is in automatic height mode. The parent element is in the automatic height mode when its height is not given but determined from the heights of the child elements. If so, then step 504 is followed by step 508. Otherwise step 504 is followed by step 506.

In step 506, the processor determines the height of the parent element by adding all the height of the child elements. Step 506 is followed by step 508.

In step 508, the processor exits method 200.

As described above, FIGS. 6 to 8 are a flowchart for method 600 to layout a parent element with vertically arranged child elements in one embodiment of the invention.

Referring to FIG. 6, in step 602, the processor determines the net width of the parent element (WidthNet) as described above. Step 602 is followed by step 604.

In step 604, the processor determines if the parent element has a set height. If the parent element has a set height, then step 604 is followed by step 668. Otherwise step 604 is followed by step 608.

In step 606, the processor determines the net height of the parent element (HeightNet) as described above.

In step 608, the processor starts to loop through child elements within the parent element. Step 608 is followed by step 610.

In step 610, the processor sets the maximum height available for the current child element equal to the net height. If the current child element has a fixed width, then the processor sets the maximum width available for the current child element as the fixed width. The fixed width is specified in the XML code for the child element. If the current child element does not have a fixed width, the processor sets the maximum width available for the current child element equal to the net width. Note that in the first pass through step 610, the net width is set to a value without any limit. Step 610 is followed by step 612.

In step 612, the processor determines if the current child element has a fixed height. In other words, the processor determines if the current child element is a SFS element. If so, step 612 is followed by step 614. Otherwise step 612 is followed by step 620.

In step 614, the processor allocates the fixed height to the child element. The fixed height is specified in the XML code for the child element. If there is insufficient height to allocate to all the child elements with fixed heights, then later child elements in the vertical arrangement are cropped. Step 614 is followed by step 616.

In step 616, the processor determines the layout of the current child element using method 200 or 600 depending on the arrangement of its child elements. As described above, the overall process is recursive. At the end of step 6166, the processor has determined the width, the height, and the starting point of the current child element (e.g., the upper left comer of the current child element). Step 616 is followed by step 618.

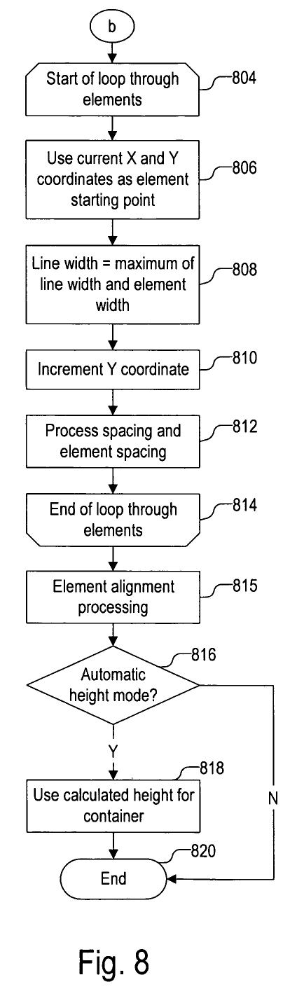

In step 618, the processor increments the total allocated height to all child elements (HeightNew) by the allocated height to the current child element (Height). Furthermore, the processor increments the total allocated height to all child elements (HeightNew) by the height of a default space element if neither the current child element nor the next child element is a space element. This is because a default space element will be inserted between the current child element and the next child element in step 812 (FIG. 8) is neither of them is a space element. Step 618 is followed by step 634.

In step 620, the processor determines if the current child element has a height that is to be proportional to the available height. In other words, the processor determines if the current child element is a SPR element. If so, step 620 is followed by step 621. Otherwise step 620 is followed by step 626.

In step 621, the processor determines if the net height (HeightNet) is greater than zero. In other words, the processor determines if the parent element is a SFS element. This ensures that the processor can divide the height of the parent element among its SPR child elements as the processor cannot divide a variable height among its SPR child elements. If the processor determines the net height (HeightNet) is greater than zero, then step 621 is followed by step 622. Otherwise step 621 is followed by step 628.

In step 622, the processor increments the total weight of all SPR elements (RemainingTotal) by the weight of the current child element (HeightSpecified). The weight is specified in the XML code for the current child element. Step 622 is followed by step 624.

In step 624, the processor increments the total minimum height of all SPR elements (RemainingMin) by the minimum height of the current child element (HeightMinFixed), if any. The minimum height is specified in the XML code for the current child element. Step 624 is followed by step 634.

In step 626, the processor determines if the child element has a height that is determined by the size of its content. In other words, the processor determines if the current child element is a SBC element. If so, then step 626 is followed by step 628. Otherwise step 626 is followed by step 820, which ends method 600. In actuality, step 626 is always followed by step 628 because the child element must be a SBC element if it is not a SFS element or a SPR element.

In step 628, the processor determines the layout for the current child element. At the end of step 628, the processor would have determined the width, the height, and the upper left corner of the current child element. Step 628 is followed by step 630.

In step 630, the processor determines if the allocated height of the current child element (Height) determined in step 628 is less than the minimum height of the current child element (HeightMinFixed). The minimum height is specified in the XML code for the current child element. If so, then step 630 is followed by step 631. Otherwise step 630 is followed by step 632.

In step 631, the processor allocates the height of the current child element (Height) equal to minimum height of the current child element (HeightMinFixed). Step 631 is followed by step 632.

In step 632, the processor increments the total allocated height to all child elements (HeightNew) by the allocated height to the current child element (Height). Furthermore, the processor increments the total allocated height to all child elements (HeightNew) by the height of a default space element if neither the current child element nor the next child element is a space element. Step 632 is followed by step 634.

In step 634, the processor loops to step 608 if there is a child element that has not been processed. Otherwise step 634 is followed by step 702.

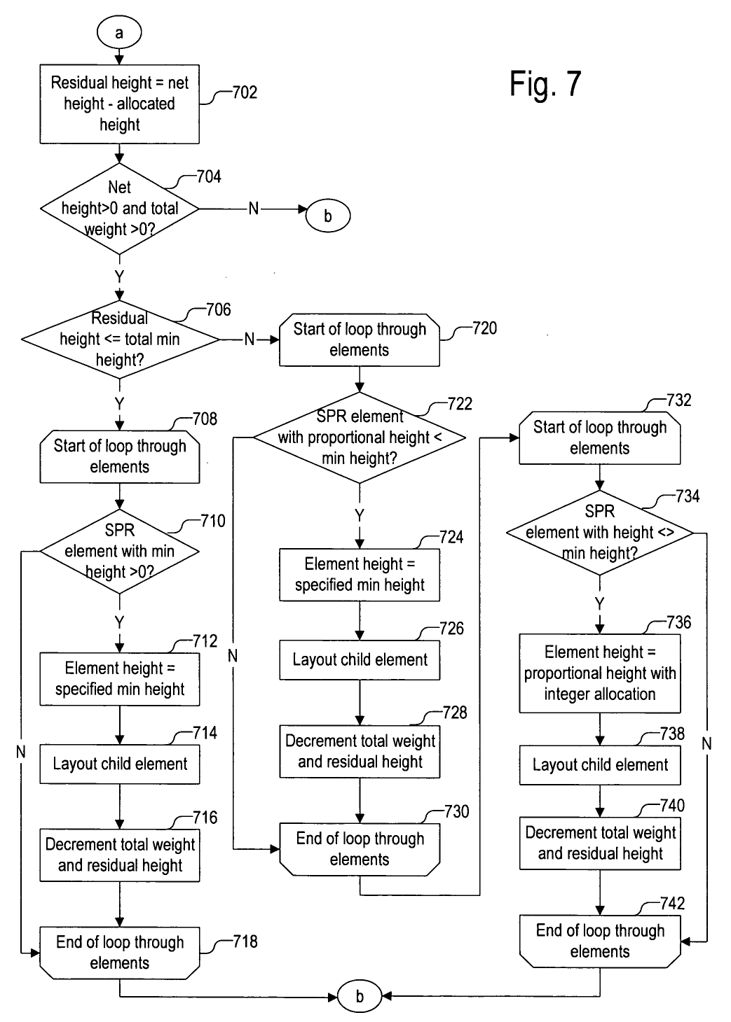

Referring to FIG. 7, in step 702, the processor determines the remaining height that has not been allocated to the child elements (HeightRemaining). The remaining height (HeightRemaining) is equal to the net height (HeightNet) minus the total allocated height to all child elements (HeightNew). Also in step 702, the current X coordinate (Left) and the current Y coordinate (Top) are initialized as zero, and that the current X coordinate remains at zero in the vertical layout mode. The processor uses these two variables to track the current location in a vertical line that it is handling. The current location is used as the starting point of the current child element. Step 702 is followed by step 704.

In step 704, the processor determines if the net height (HightNet) and the total weight of all SPR elements (RemainingTotal) are both greater than zero. In other words, the processor determines if the parent element is a SFS element and at least one of the child elements is a SPR element. If so, then step 704 is followed by step 706. Otherwise step 704 is followed by step 804.

In step 706, the processor determines if the remaining height (HeightRemaining) is less than or equal to the total minimum height of all SPR elements (HeightMinimum). If so, then it is not possible to proportionally allocate the remaining height to all the SPR elements and meet their specified minimum heights. If the remaining height (HeightRemaining) is less than or equal to the total minimum height of all SPR elements (HeightMinimum), then step 706 is followed by step 708. Otherwise step 706 is followed by step 720.

In step 708, the processor starts to loop through the child elements. Step 708 is followed by step 710.

In step 710, the processor determines if the current child element is a SPR element and has a minimum height (HeightMinFixed) greater than zero. In other words, the processor determines if the current child element is a SPR element and has a specified minimum height (HeightMinFixed). If so, step 710 is followed by step 712. Otherwise step 710 is followed by step 718. The result of this step is that if there is insufficient height to allocate to all SPR elements, then any SPR element without a minimum height would not be displayed.

In step 712, the processor allocates to the current child element its minimum height (HeightMinFixed). The minimum height (HeightMinFixed) is specified in the XML code for the current child element. Step 712 is followed by step 714.

In step 714, the processor determines the layout of the child element. At the end of step 714, the processor has determined the width, the height, and the starting point of the current child element (e.g., the upper left comer of the current child element). Step 714 is followed by step 716.

In step 716, the processor decrements the total weight of all SPR elements (RemainingTotal) by the weight of the current child element (HeightSpecified). The weight is specified in the XML code for the current child element. The processor also decrements the remaining height that has not been allocated to the child elements (HeightRemaining) by the allocated height to the current child element (Height). Step 716 is followed by step 718.

In step 718, the processor loops to step 708 if there is a child element that has not been processed. Otherwise step 718 is followed by step 804.

In step 720, the processor starts to loop through the child elements. Step 720 is followed by step 722.

In step 722, the processor determines if the current child element is a SPR element and has a proportional height that is less than its minimum height. The processor determines the proportional width of the current child element using Equation 1 described above. If so, then step 722 is followed by step 724. Otherwise step 722 is followed by step 730.

In step 724, the processor allocates the minimum height specified for the current child element (HeightMinFixed) as the height of the current child element (Height). The minimum height is specified in the XML code for the current child element. Step 724 is followed by step 726.

In step 726, the processor determines the layout of the child element. At the end of step 726, the processor has determined the width, the height, and the starting point of the current child element (e.g., the upper left comer of the current child element). Step 726 is followed by step 728.

In step 728, the processor decrements the total weight of all SPR elements (RemainingTotal) by the specified weight of the current child element (HeightSpecified). The weight is specified in the XML code for the current child element. The processor also decrements the remaining height that has not been allocated to the child elements (HeightRemaining) by the allocated height to the current child element (Height). Step 728 is followed by step 730.

In step 730, the processor loops to step 720 if there is a child element that has not been processed. Otherwise step 730 is followed by step 732.

In step 732, the processor starts to loop through the child elements. Step 732 is followed by step 734.

In step 734, the processor determines if the current child element is a SPR element and has a height greater than or less than its specified minimum height. In other words, the processor determines if the current child element is a SPR element and has been allocated its minimum height in the loop through steps 720 to 730. If so, then step 734 is followed by step 736. Otherwise step 734 is followed by step 742.

In step 736, the processor allocates a height to the current child element according to equation 1. In one embodiment, an integer allocation algorithm is implemented to use all remaining height when the remaining height is not equally divisible among the child elements. Step 736 is followed by step 738.

In step 738, the processor determines the layout of the current child element. At the end of step 738, the processor has determined the width, the height, and the starting point of the current child element (e.g., the upper left corner of the current child element). Step 738 is followed by step 740.

In step 740, the processor decrements the total weight of all SPR elements (RemainingTotal) by the weight of the current child element (HeightSpecified). The weight is specified in the XML code for the current child element. The processor also decrements the remaining height that has not been allocated to the child elements (HeightRemaining) by the allocated height to the current child element (Height). Step 740 is followed by step 742.

In step 742, the processor loops to step 732 if there is a child element that has not been processed. Otherwise step 742 is followed by step 804.

Referring to FIG. 8, in step 804, the processor starts to loop through the child elements. Step 804 is followed by step 806.

In step 806, the processor uses the current X coordinate (Left) and the current Y coordinate (Top) as the starting point for the current child element and places the child element at the current X and Y coordinates. Step 806 is followed by step 808.

In step 808, the processor sets the line width for the current line (WidthNew) as the greater of the current line width (WidthNew) and the line width of the current child element (Width). In other words, the processor sets the line width as the greatest of all the line widths of the child elements. Step 808 is followed by step 810.

In step 810, the processor increments the Y coordinate (Top) by the allocated height of the current child element (Height). Step 810 is followed by step 812.

In step 812, the processor handles the spacing and element spacing. Normally a default space element is inserted between adjacent child elements. However, the default space element is not inserted when one of the adjacent child elements is already a space element. Step 812 is followed by step 814.

In step 814, the processor loops to step 804 if there is a child element that has not been processed. Otherwise step 814 is followed by step 815.

In step 815, the processor performs element alignment processing. Each child element can be set to one of three alignment groups: left aligned, centered, and right aligned. The alignment group for each child element is specified in the XML code for the child element. If the alignment group is not specified, the child element by default belongs to the left aligned group. Step 815 is followed by step 816.

In step 816, the processor determines if the parent element is in automatic height mode. The parent element is in the automatic height mode when its height is not given but determined from the heights of the child elements. If so, then step 816 is followed by step 818. Otherwise step 816 is followed by step 820.

In step 816, the processor determines the height of the parent element using the height of the child elements. Step 816 is followed by step 820.

In step 820, the processor exits method 600.

Various other adaptations and combinations of features of the embodiments disclosed are within the scope of the invention. Numerous embodiments are encompassed by the following claims.

What is claimed is:

1. A method for laying out child elements in a parent element in a graphic user interface, the method for each child element comprising:
if a dimension of the child element is fixed:
allocating a fixed dimension to the dimension of the child element from a remaining dimension of the parent element that has not been allocated;
laying out any grandchild element in the child element;
if the dimension of the child element is variable based on a content of the child element:
determining a required dimension based on the content of the child element;
allocating the required dimension to the dimension of the child element from the remaining dimension of the parent element.

2. The method of claim 1, wherein the dimension of the child element is a width of the child element, the method further comprising:
if the dimension of the child element is proportional based on a weight of the child element and the remaining dimension of the parent element:
if the remaining dimension of the parent element is greater than a total required minimum dimension of the child element and another child element:
determining a proportional dimension of the child element based on the weight of the child element and the remaining dimension of the parent element;
if the proportional dimension of the child element is greater than or equal to a required minimum dimension of the child element:
allocating the proportional dimension of the child element to the dimension of the child element;
laying out any grandchild element in the child element.

3. The method of claim 2, further comprising:
if the dimension of the child element is proportional based on the weight of the child element and the remaining dimension of the parent element:
if the remaining dimension of the parent element is greater than a total required minimum dimension of the child element and another child element:
if the proportional dimension of the child element is less than the required minimum dimension of the child element:
allocating the required minimum dimension of the child element to the dimension of the child element;
laying out any grandchild element in the child element.

4. The method of claim 3, further comprising:
if the dimension of the child element is proportional based on the weight of the child element and the remaining dimension of the parent element:
if the remaining dimension of the parent element is less than or equal to the total required minimum dimension of the child element and the another child element:
allocating the required minimum dimension of the child element to the dimension of the child element;
laying out any grandchild element in the child element.

5. The method of claim 2, further comprising:
if the parent element is in a single line mode where the child elements of the parent element are arranged in one line:
placing the child element on the one line;
setting a height of the one line as a greatest of the child elements on the one line.

6. The method of claim 5, further comprising:
if the parent element is in a single line mode where the child elements of the parent element are arranged in one line:
inserting a spacing element between adjacent child elements in the one line when neither of the adjacent child elements is the space element.

7. The method of claim 5, further comprising:
if the parent element is a multiple single line mode where the child elements of the parent element can be arranged in multiple lines:
if the child element is at least partially located beyond a dimension of the parent element and the child element is not a space element:
placing the child element on a new line;
setting the height of the new line as the greatest of the child elements arranged on the new line.

8. The method of claim 7, further comprising:
if the parent element is in a multiple line mode where the child elements of the parent element can be arranged on multiple lines:
if the child element is located within the dimension of the parent element:
placing the child element in the one line;
setting the height of the new line as the greatest of the child elements arranged on the new line.

9. The method of claim 7, further comprising:
if the parent element is a multiple single line mode where the child elements of the parent element can be arranged in multiple lines:
if the child element is at least partially located beyond a dimension of the parent element and the child element is not a space element:
inserting a spacing element between adjacent child elements in the one line when neither of the adjacent child elements is the space element.

10. The method of claim 7, further comprising:
performing final line processing.

11. The method of claim 7, further comprising:
if a height of the parent element is not fixed:
determining the height of the parent element from the height of the one line and the height of the new line.

12. The method of claim 1, wherein the dimension of the child element is a height of the child element, the method further comprising:
if the dimension of the child element is proportional based on a weight of the child element and the remaining dimension of the parent element:
if the remaining dimension of the parent element is greater than a total required minimum dimension of the child element and another child element:
if a proportional dimension of the child element is greater than or equal to a required minimum dimension of the child element:
allocating the proportional dimension of the child element to the dimension of the child element;
laying out any grandchild element in the child element.

13. The method of claim 12, further comprising:
if the dimension of the child element is proportional based on the weight of the child element and the remaining dimension of the parent element:
if the remaining dimension of the parent element is greater than a total required minimum dimension of the child element and another child element:
if the proportional dimension of the child element is less than the required minimum dimension of the child element:
allocating the required minimum dimension of the child element to the dimension of the child element;
laying out any grandchild element in the child element.

14. The method of claim 13, further comprising:
if the dimension of the child element is proportional based on the weight of the child element and the remaining dimension of the parent element:
if the remaining dimension of the parent element is less than or equal to the total required minimum dimension of the child element and the another child element:
allocating the required minimum dimension of the child element to the dimension of the child element;
laying out any grandchild element in the child element.

15. The method of claim 13, further comprising:
arranging the child elements of the parent element in one line:
setting a width of the one line as a greatest of the child elements in the one line.

16. The method of claim 15, further comprising:
inserting a spacing element between adjacent child elements in the one line when neither of the adjacent child elements is the space element.

17. The method of claim 15, further comprising:
performing final line processing.

18. The method of claim 15, further comprising:
if a height of the parent element is not fixed:
determining the height of the parent element from a height of the one line.
